(19) United States
(12) Patent Application Publication
(10) Pub. No.: US 2026/0328351 A1
(43) Pub. Date: Oct. 22, 2026

(54) MODULAR LIGHTING FIXTURE

(71) Applicant: USAI, LLC, New Windsor, NY (US)

(72) Inventors: Bonnie Littman Gatof, Scarsdale, NY (US); Sean Gaydos, Lakewood, CO (US); Oriana Starr, New Paltz, NY (US); Eran Moses, New Windsor, NY (US); John M. Reilly, Newburgh, NY (US)

(21) Appl. No.: 19/651,561

(22) Filed: Apr. 17, 2026

Related U.S. Application Data
(60) Provisional application No. 63/790,210, filed on Apr. 17, 2025.

(51) Int. Cl. F21S 2/00; F21V 21/005; F21V 21/104; F21V 21/14; F21V 21/35; F21V 23/00; F21V 23/06; F21V 29/73

(52) U.S. Cl. CPC F21S 2/005; F21V 21/005; F21V 21/104; F21V 21/14; F21V 21/35; F21V 23/002; F21V 23/004; F21V 23/06; F21V 29/73

(57) ABSTRACT

A modular lighting fixture has a holder assembly and has a lighting module having a light engine connected to a first end of a connector module. A second end of the connector module is removably and movably mountable to a mounting interface of the holder assembly. The connector module has electrical conductors configured to connect to an electrical interface of the holder assembly. The light engine is connected to the electrical conductors of the connector module. The lighting module is operable to move along the holder assembly in a range of positions while maintaining a mounting connection to the mounting interface and an electrical connection to the electrical interface and optionally a thermal connection to thermal interface of the holder assembly.

### BACKGROUND OF THE INVENTION

Lighting fixtures are commonly designed and manufactured as purpose-built units tailored to a specific installation type and lighting effect. For example, distinct fixture constructions are typically provided for recessed downlighting, wall washing, sloped ceiling applications, and pendant lighting. Each such fixture type often incorporates dedicated housings, mounting structures, optical elements, and electrical components suited to its intended use. As a result, even within a single product family, multiple discrete fixture models are required to address different installation conditions and lighting objectives.

This conventional approach presents several drawbacks. From a manufacturing and distribution standpoint, maintaining a wide variety of fixture configurations increases design complexity, tooling requirements, and inventory burdens. Distributors and installers must stock numerous fixture types to accommodate varying project requirements, leading to inefficiencies and increased costs. From an installation perspective, selecting and installing the correct fixture often requires advance planning and limits flexibility in adapting to unforeseen site conditions, such as variations in ceiling geometry or evolving lighting design preferences.

Additionally, traditional fixtures are generally not readily reconfigurable once installed. If a different lighting effect or mounting orientation is desired—such as converting a downlight to a wall wash configuration or adapting a fixture for a sloped ceiling—replacement of the entire fixture is often required. This can involve significant labor, increased material costs, and disruption to finished architectural surfaces. Such limitations are particularly pronounced in commercial and architectural environments where lighting layouts may evolve over time or require customization during installation.

Accordingly, there exists a need for improved lighting fixture systems that provide greater flexibility in configuration while reducing the complexity associated with manufacturing, inventory, and installation. In particular, a need exists for a modular lighting fixture architecture in which a set of standardized components can be selectively combined to form multiple fixture types, such as downlights, wall wash fixtures, sloped ceiling fixtures, and pendant lights, and other configurations. Such a modular approach would enable streamlined assembly, facilitate adaptation to diverse installation conditions, and allow for efficient reconfiguration without requiring complete fixture replacement.

There is further a need for lighting systems that simplify installation and maintenance by enabling components to be easily assembled, disassembled, and interchanged, while maintaining reliable mechanical, optical, and electrical performance. By addressing these and other shortcomings of conventional lighting fixtures, a modular lighting system can provide enhanced versatility, reduced cost, and improved user convenience across a wide range of lighting applications.

### SUMMARY OF THE INVENTION

In an embodiment, the modular lighting fixture has a holder assembly having a mounting interface and an electrical interface and has a lighting module. The lighting module includes a connector module having first and second ends and includes a light engine having light emitting elements.

The light engine is mounted to the first end of the connector module and the second end of the connector module is removably and movably mountable to the mounting interface of the holder assembly.

The connector module includes electrical conductors configured to connect to the electrical interface of the holder assembly. The light engine is connected to the electrical conductors of the connector module, and the lighting module is operable to move along the holder assembly in a range of positions while maintaining a mounting connection to the mounting interface and an electrical connection to the electrical interface.

In an embodiment, the holder assembly includes a thermal interface, the first end of the connector module includes a first thermal interface and the second end of the connector module includes a second thermal interface, and the light engine is in thermal connection with the first thermal interface of the connector module.

The connector module comprises a material having high thermal conductivity which is configured to conduct heat from the light engine to the thermal interface of the holder assembly, and the lighting module is operable to move along the holder assembly in the range of positions while maintaining a thermal connection to thermal interface of the holder assembly.

In an embodiment the light engine includes an integrated controller which is operable to receive power or control signals to drive the light emitting elements.

In an embodiment the holder assembly includes a substrate having a channel and the electrical interface is disposed with the channel.

In an embodiment the electrical interface includes a conductor exposed along a length of the holder assembly and an electrically insulating sleeve disposed between the conductor and the substrate.

In an embodiment the modular lighting fixture is configured to connect to a support structure, and the holder assembly is operable to rotate or translate relative to the support structure.

In an embodiment the holder assembly has first and second electrical interfaces and the lighting fixture has first and second lighting modules.

Each lighting module includes a connector module having first and second ends, and each lighting module includes a light engine having light emitting elements, and the light engine is mounted to the first end of the connector module.

The second end of each connector modules is removably and movably mountable to the mounting interface of the holder assembly.

The first connector module includes electrical conductors configured to connect to the first electrical interface of the holder assembly, and the second connector module includes electrical conductors configured to connect to the second electrical interface of the holder assembly.

The light engine of each lighting module is connected to the electrical conductors of the associated connector module, and each lighting module is operable to move along the holder assembly independently in a range of positions while maintaining a mounting connection to the mounting interface and an electrical connection to the electrical interface.

In an embodiment the connector module includes an elongated shaft disposed between the first and second ends of the connector module; whereby the lighting fixture is in the form of a pendant.

In an embodiment the connector module includes a first connector module and a second connector module connected in series, where the light engine is connected to the first connector module and the second connector module is removably and moveably mountable to the holder assembly.

### BRIEF DESCRIPTION OF THE DRAWINGS

FIG. 1A is a schematic representation of a lighting fixture constructed in accordance with the invention, showing the lighting module in a downlight position.

FIG. 1B is a schematic representation of the lighting fixture of FIG. 1A, showing the lighting module in a tilted position.

FIG. 2 is a schematic representation of a lighting module for a lighting fixture constructed in accordance with the invention.

FIGS. 3A, 3B and 3C are schematic representations of several examples for a lighting module for a lighting fixture constructed in accordance with the invention.

FIGS. 4 and 5 are schematic representations of several examples for a lighting module for a lighting fixture constructed in accordance with the invention.

FIG. 6 is a schematic representation of a holder assembly for a lighting fixture constructed in accordance with the invention, in a linear configuration.

FIG. 7 is a schematic representation of a holder assembly for a lighting fixture constructed in accordance with the invention, showing mounting and electrical interfaces.

FIG. 8A is a close-up plan view schematic representation of the electrical interface of the holder assembly of FIG. 7, showing a conductor and isolation sleeve.

FIG. 8B is a close-up cross-section schematic representation of the electrical interface of FIG. 8A, showing the conductor and isolation sleeve.

FIG. 9A is a close-up plan view schematic representation of the electrical interface of the holder assembly of FIG. 7, showing a flexible PCB.

FIG. 9B is a close-up cross-section schematic representation of the electrical interface of FIG. 9A, showing the flexible PCB.

FIG. 10 is a schematic representation of a lighting fixture constructed in accordance with the invention, having multiple lighting modules in a first configuration.

FIG. 11 is a schematic representation of a lighting fixture constructed in accordance with the invention, having multiple lighting modules in a second configuration.

FIG. 12 is a schematic representation of a holder assembly for a lighting fixture constructed in accordance with the invention, showing mounting and electrical interfaces for multiple lighting modules.

FIG. 13 is a schematic representation of a composite lighting module for a lighting fixture constructed in accordance with the invention.

FIG. 14 is a schematic representation of a lighting fixture constructed in accordance with the invention, having a shape adapter for the lighting module.

FIG. 15 is a schematic representation of a lighting fixture constructed in accordance with the invention, in an inclined configuration.

FIG. 16 is a schematic representation of a lighting fixture constructed in accordance with the invention, in pendant configuration.

### DETAILED DESCRIPTION OF THE PREFERRED EMBODIMENTS

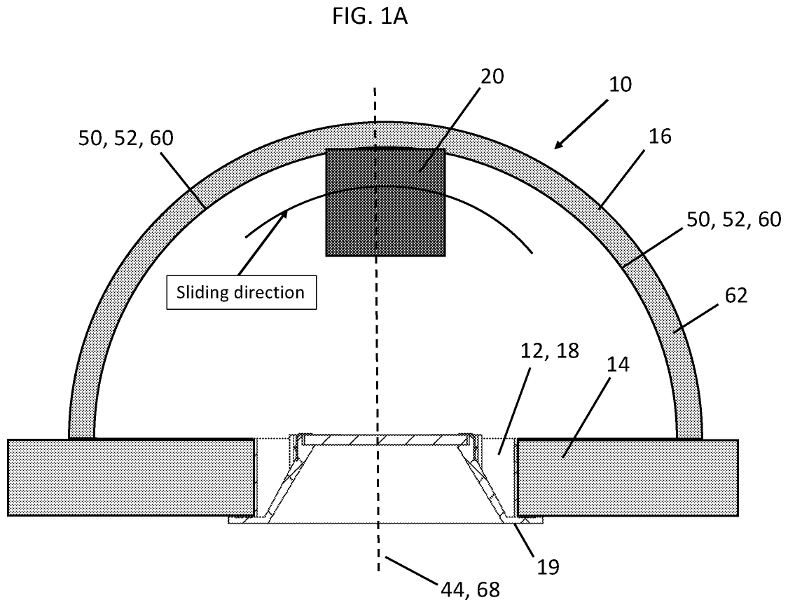

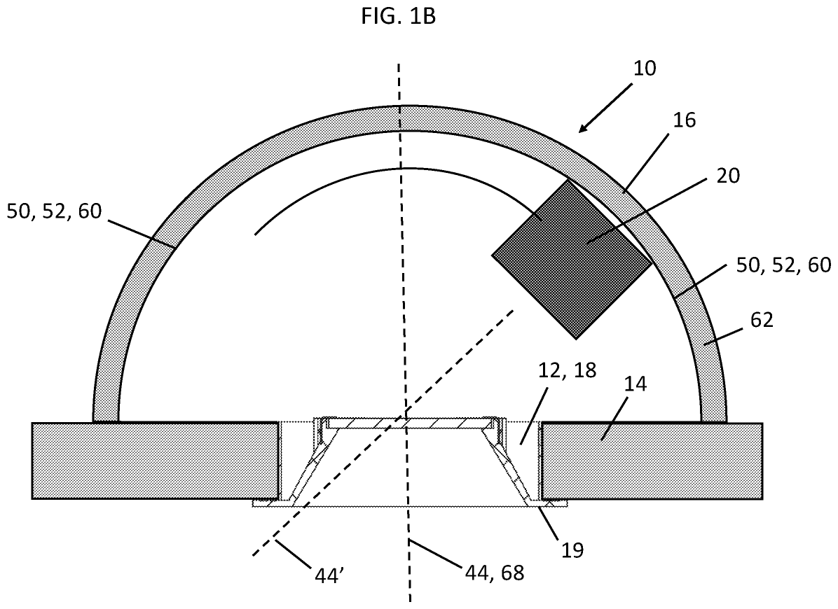

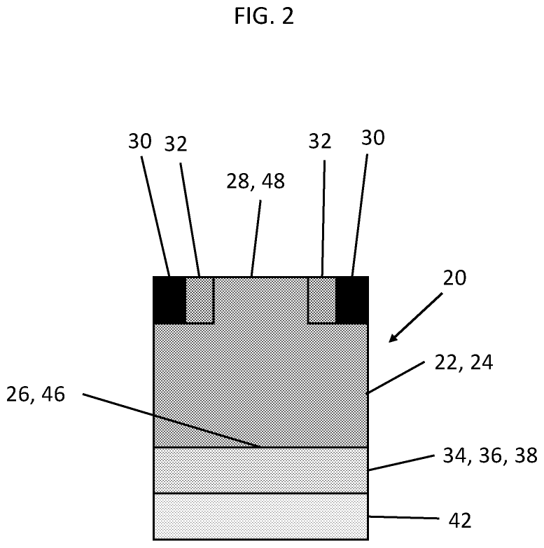

Referring to FIGS. 1-8B, a first embodiment, the lighting fixture 10 can be configured as a recessed light fixture adapted mount to a support structure (not shown) and adapted to project light into a room. For example, the lighting fixture 10 can be adapted to project light through an aperture 18 of the lighting fixture and an opening 12 in a panel 14, such as a ceiling panel. The opening 12 and/or aperture 18 can be finished with a trim element 19. In other embodiments the lighting fixture 10 could be configured as a surface mounted lighting fixture mounted to a support structure below the ceiling/wall plane, or it could be a suspended/pendant lighting fixture such that the lighting fixture 10 is hung from a support structure via cables, wires, pipe, or other common means available for those lighting fixture types.

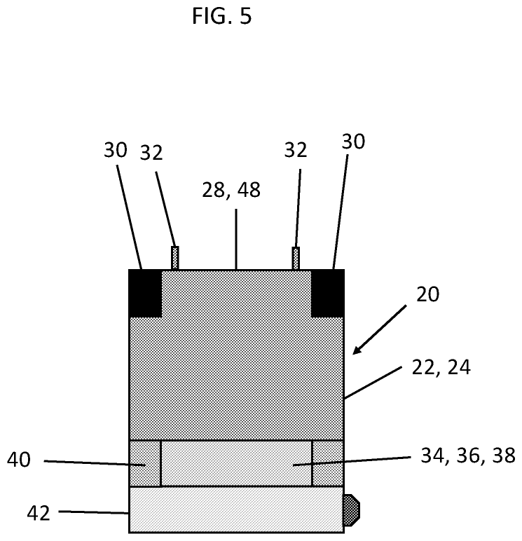

The lighting fixture 10 includes a holder assembly 16 which is preferably connected to the support structure either directly or indirectly, such as via a housing or enclosure (not shown). The holder assembly 16 can be configured in an arcuate shape (e.g., FIG. 1A), a linear shape (e.g., FIG. 6), or other shapes.

The holder assembly 16 may be fixed relative to the aperture 18, panel opening 12 and/or support structure. Alternatively, the holder assembly 16 can be configured to rotate about a rotation axis 68 which axis may be parallel or co-linear to the optical axis 44 of the lighting module 20, in the downlight position. This can provide the ability to aim light emitted by the lighting fixture when in a tilted position. Alternatively, or additionally, the holder assembly 16 can be configured to translate perpendicular to the optical axis 44 of the lighting module 20, in the downlight position. The rotation and/or movement of the holder assembly 16 can be affected by a motor or other mechanical and/or electrical methods, for example to allow for remote adjustment of its position. This can provide the ability to optimize light emitted by the lighting fixture.

The holder assembly 16 preferably has a thermal interface 60 and is preferably configured to serve as a heat sink to dissipate heat generated by the lighting fixture.

The holder assembly 16, and/or the thermal interface 60 thereof, is preferably formed of, or comprises, one or more materials having high thermal and/or electrical conductivity such as aluminum or cooper, or other metal(s) or material(s) having high thermal and/or conductivity. Alternatively, the holder assembly 16, or a substrate 62 portion thereof, can comprise or be formed of plastic or resin and/or non-electrical and/or non-highly thermally conductive material.

The lighting fixture 10 includes a lighting module 20 which is removably mountable to the holder assembly 16, preferably through the opening 12 and aperture 18, from within the room. The lighting module 20 preferably includes a mounting system 30 operable to removably mount the lighting module 20 to holder assembly 16. The mounting system 30 can include mechanical and/or magnetic connections.

The mounting system 30 of the lighting module 20 can include magnets or mechanical holding means such as clamps, cams, twist locks, spring mounts, snaps, etc., whose function is to attach the lighting module 20 to the holder assembly 16. As an example, magnet components of the mounting system 30 can be connected to the connector module 22 via adhesive or mechanical fasteners and/or press-fit into the connector module 22, (e.g., into the base 24 thereof).

Preferably, the lighting module 20 is selectively movably mounted to the holder assembly 16 to allow adjustment of the angle and/or position of light emitted into the room. For example, the lighting module 20 can preferably be mounted to the holder assembly 16 in a downlight position (e.g., FIG. 1A) wherein an optical axis 44 of the lighting module is perpendicular to the aperture 18 (and for example, passes through a center of the aperture), and can be selectively moved, while remaining connected to the holder assembly 16, to a tilted or wall wash position (e.g., FIG. 1B) wherein the optical axis 44 is at a substantial angle as compared to the downlight position.

The lighting module 20 includes a connector module 22 which is operable to mount to the holder assembly 16. The connector module 22 has a base 24 which is preferable formed of, or comprises, one or more materials having high thermal conductivity such as aluminum or cooper, or other metal(s) or material(s) having high thermal conductivity. The connector module 22 has a first thermal interface 26 and a second thermal interface 28 disposed on opposite sides of the connector module 22 and/or base 24. The first thermal interface 26 is configured to interface and receive heat from a light engine 34 of the lighting fixture 10, and the second thermal interface 28 is configured to interface with the thermal interface 60 of the holder assembly 16, and to thereby deliver heat to the holder assembly 16 for dissipation.

The light engine 34 is mounted to the connector module 22 of the lighting module 20, preferably to (or adjacent to) the first thermal interface 26. The light engine 34 includes one or more light emitting elements 36, such as LEDs, COB(s), other light emitting semiconductors, and/or other suitable light sources. The light emitting elements 36 can be mounted on a substrate 38.

The lighting module 20 can also include an optical system 42, for example connected to the light engine, connector module and/or base. The optical system 42 is preferably configured to receive light emitted by the light engine and to transmit such light through the aperture 18.

The optical system 42 can include a commercially available TIR (total internal reflection) optic and holder, which, for example, can be twist lock mounted to the lighting module 20, such as to the connector module 22 and/or base 24 thereof. The optical system 42 can include a reflector, or other commonly available optical components and could also be attached via other mechanical means, including magnets, screws, rivets, snaps.

As a further example, the optical system 42 can include an adaptive optical system having various modification profiles based on desired inputs from the end user. These inputs could be achieved by manual mechanical adjustments, motorized mechanical adjustments, manual electrical adjustments (via dip switch or other alternative means), or control based electrical adjustments (via wireless or wired communications to the integrated controller, or a controller proximate to the fixture, or a power supply within a reasonable distance from the fixture.

Connected to the optical system 42 could be separate accessory holders, with the primary purpose of them being to further modify the beam profile. These accessory holders could contain optics, lenses, filters, films, louvers (hexcell, radial, linear, additional patterns etc.), barndoors, snoots etc. This is not an exhaustive list of accessories that may be fitted but rather examples of certain embodiments. In certain instances, it will be desirable to stack these accessories on top of each other in various arrangements to create a desired end effect not possible with only one accessory. For instance, a diffusion film could be used to enhance color mixing of the beam, with a hexcell louver on top of it to reduce glare when looking at the beam off angle, and finally a metal snoot on top of that to shield the light source from the end user and create a defined cut off of the beam and reduce field light. No one accessory could achieve all of this, so stacking them and being able to adjust their position within lighting module 20 leads to maximum flexibility.

In some instances, an accessory holder can be designed to hold multiple accessories within it to reduce the lighting module size as well as reduce complexity in the assembly. An embodiment of this could include a solite glass lens and a diffusion film being contained in one accessory holder. This is just given as an example and is not an exhaustive list of the possibilities. Furthermore, these accessories could include non-optical components that serve primarily to enhance the aesthetic of the nugget assembly and the overall light fixture. This could include a casing to cover the nugget assembly and provide a clean outer appearance, a glass or plastic snoot, or any number of other functions.

The light engine 34 can also include an integrated controller 40 which is operable to control the light emitting elements 36 in response to power and/or control signals. For example, the controller 40 can comprise a driver system operable to receive a pulse-width modulated (PWM) constant voltage PWM power and to drive the light emitting elements 36 with PWM constant current power, such as disclosed in U.S. patent application Ser. No. 18/496,553 and U.S. patent application Ser. No. 19/646,457 titled Constant Voltage PWM to Constant Current PWM Driver System with Thermal and Current Feedback, the disclosures of which are incorporated herein in their entireties.

For example, the integrated controller 40 can be configured to receive constant voltage and convert it to constant current and is able to reduce the output current to achieve dimming of the light engine, as well as turning it off. This is achieved by the integrated controller sensing and reading a PWM (pulse width module) signal coming from the constant voltage being provided by or via the holder assembly 16. This can also achieve turning off the light engine fully. The integrated controller 40 can contain dip switches to change the output current which is connected to the light engine. In other embodiments, the integrated controller 40 can also change the output current via a rotary dial, potentiometer, sliding switch, or a push button switch, or other suitable controls.

The integrated controller 40 can be configured to utilize varying electrical architectures, including for example AC/DC (constant current), AC/DC (constant voltage), DC/DC (constant current), DC/DC (constant voltage), and utilize varying dimming protocols (for example, Phase Cut, Forward Phase, Reverse Phase, 0-10V, DALI, DMX, PWM) and potentially contain wireless protocols (Athena, Casambi, nLight Air).

Alternatively, the power for the light engine 34 and any other subsequent components/sub-assemblies (such as an adaptive optical system) could come from a power supply not directly connected to the connector module 22. For example, a power supply could be connected to the holder assembly 16 or elsewhere on or in the light fixture 10.

The lighting module 20 includes electrical conductors 32 which are operable to receive power and/or control signals and to conduct such power and/or control signals to the light engine 34. The electrical conductors 32 can comprise one or more sets of conductors such as one, two or three sets of two conductors, or other amounts of conductors.

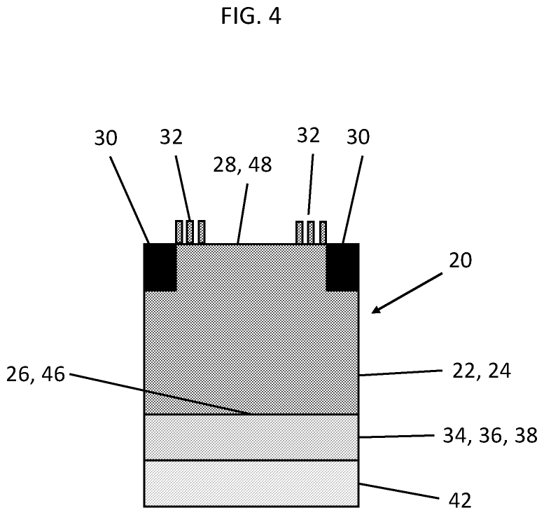

Referring specifically to FIGS. 4 and 5, the electrical conductors 32 of the lighting module 20 can extend outwardly from the second end 48 of the connector module 22. As an example, the electrical conductors 32 can comprise “pogo” pins, which are spring-biased conductors (typically formed of gold-plated brass), which allow the conductors to maintain constant contact pressure with a mating conductor. Alternatively, the electrical conductors 32 can comprise conductive springs (e.g., formed of thin stranded wire) or solid, static conductors. All the foregoing conductors 32 are configured and adapted to electrically connect with the electrical interface 52 of the holder assembly 16.

Alternatively, the conductors 32 can be eliminated and wireless power and/or control signals can be provided to the lighting module 20 (e.g., to the light engine 34) from a wireless transmitter disposed within or outside the lighting fixture 10.

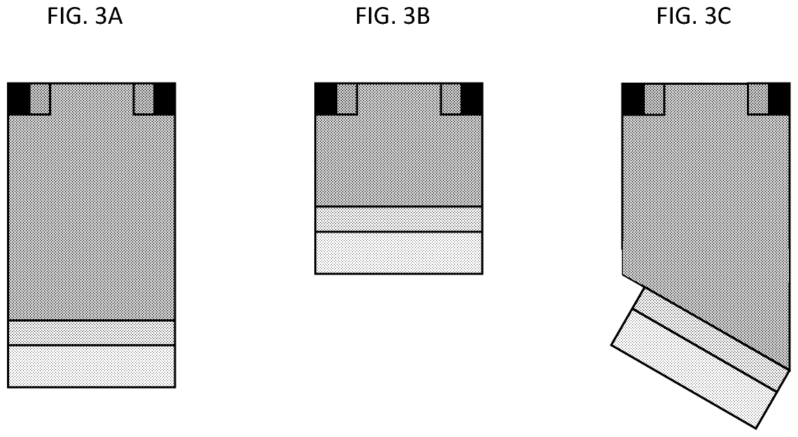

As shown (e.g., FIGS. 3A-3C), the connector module 20 of the lighting module 20 can be of various sizes and shapes. For example, a first end 46 of the connector module 22 (having the first thermal interface 26) can be substantially parallel to a second end 48 of the connector module 22 (having the second thermal interface 28). Alternatively, (FIG. 3C) the first end 46 can be at an angle relative to the second end 48, for example an angle of 5-70 degrees).

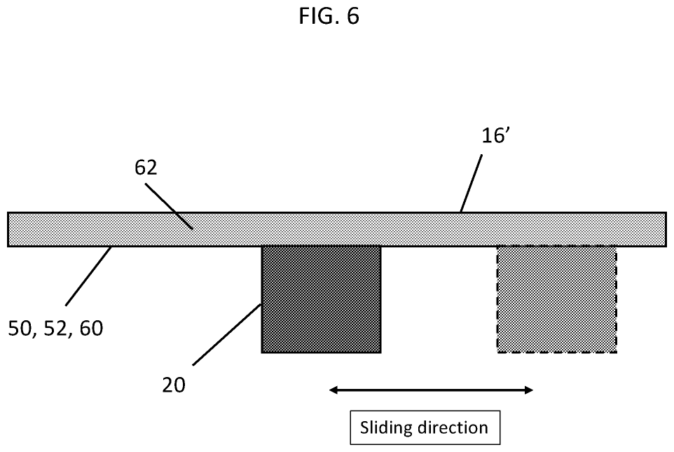

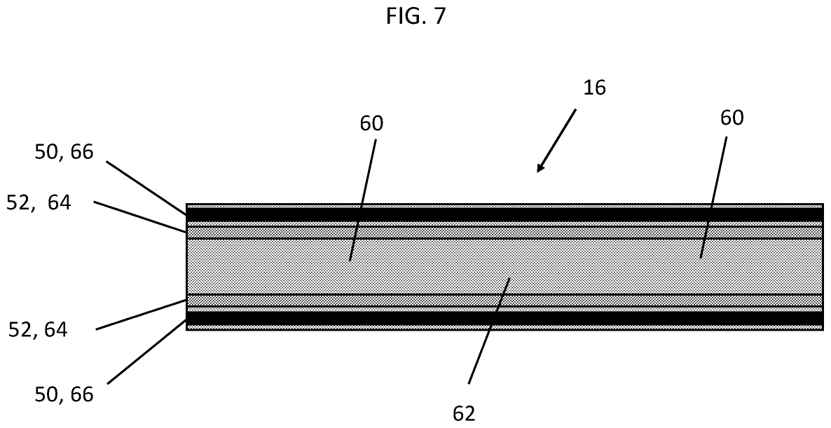

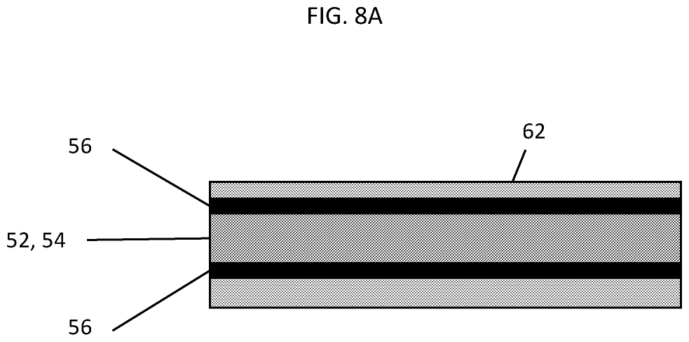

Referring specifically to FIGS. 7-8B, the holder assembly 16 preferably includes a mounting interface 50 which is operable to connect to the mounting system 30 of the lighting module 20, to thereby support the lighting module 20. The mounting interface 50 can include mechanical and/or magnetic mounting structure.

The mounting interface 50 of the holder assembly 16 can comprise ferrous strips 66 which can be attached to or within the substrate 62 of the holder assembly 16, such as by adhesive or mechanical methods, or other suitable methods. The ferrous strips 66 are configured to connect with magnetic components of the mounting system 30 of the lighting module 20. As an example, the ferrous strips 66 can be disposed wholly or partially within channels within the substrate 62. As an alternative, the substrate 62 of the holder assembly 16 can comprise ferrous material which is configured to connect with the mounting system 30 of the lighting module 20.

The holder assembly 16 also preferably includes an electrical interface 52 which is operable to electrically connect to the electrical conductors 32 of the lighting module 20 when the lighting module is mounted to the holder assembly 16. The electrical interface 52 of the holder assembly 16 is connected to a power source and/or control signal source for receiving power and/or control signals to operate the lighting fixture 10.

Preferably, the mounting interface 50 and the electrical interface 52 of the holder assembly 16 are configured to permit the lighting module 20 to removably connect to the holder assembly 16 and to permit selective movement of the lighting module 20 along the holder assembly 16 while remaining physically and electrically connected thereto.

The electrical interface 52 of the holder assembly 16 can comprise an unshielded conductor 54 contained within an insulating sleeve 56 which is disposed (e.g., press-fit) within a channel 58 set in the substrate 62 of the holder assembly 16. For example, the insulating sleeve 56 can have a U-shaped cross section and the unshielded conductor 54 can have a circular (wire) cross section or a square/rectilinear cross section, and other shapes and configurations are suitable.

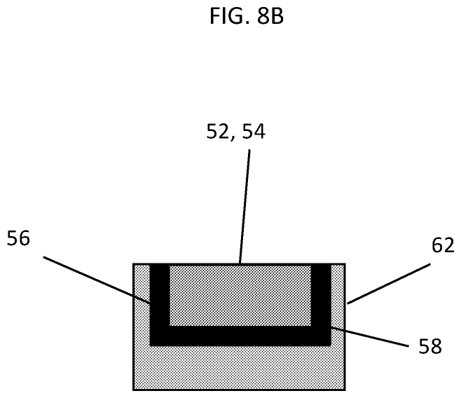

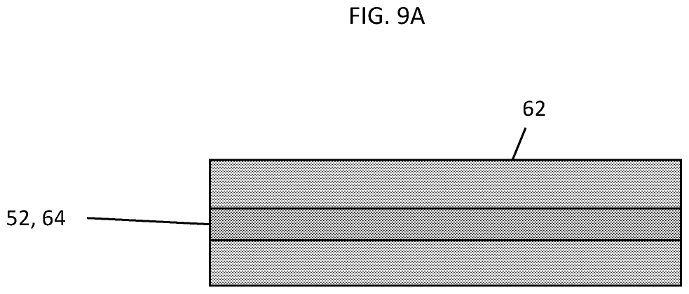

Referring specifically to FIGS. 9A and 9B, alternatively, or additionally, the electrical interface 52 of the holder assembly 16 can comprise one or more flexible printed circuit boards (PCBs) 64, with exposed conductive vias, which can be attached to or within the substrate 62 such as by adhesive or mechanical methods, or other suitable methods.

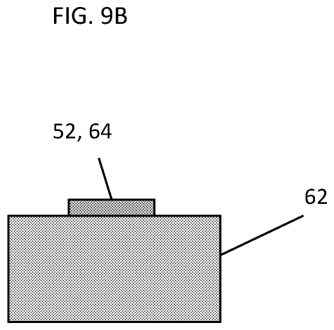

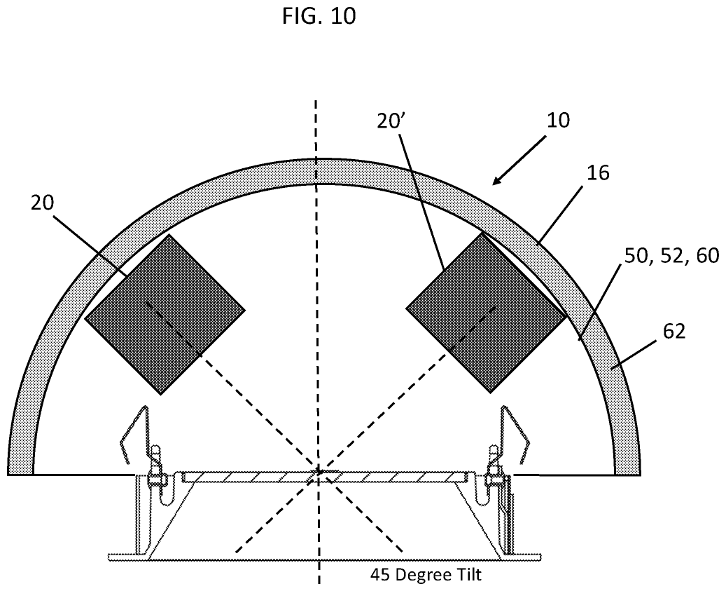

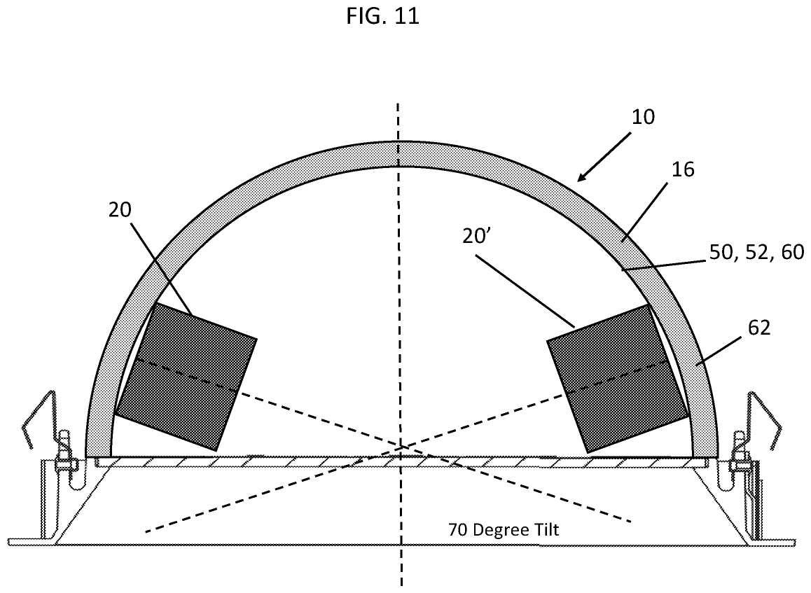

Referring to FIGS. 10-12 in an embodiment, the light fixture 10 as described above can include multiple lighting modules 20, 20′ which are independently mountable to, and independently movable relative to, the holder assembly 16″.

The holder assembly 16'′ is preferably as described above and includes multiple, independent electrical interfaces 52, 52′ as described above. Each one of the multiple electrical interfaces 52, 52′ corresponds and connects to one of the multiple lighting modules 20, 20′ such that the lighting modules 20, 20′ can be controlled independently. As can be appreciated, the multiple lighting modules 20, 20′ can also be controlled collectively by directing a single power and/or control signal to all electrical interfaces.

The holder assembly 16″ preferably includes a mounting interface 50 as described herein which is operable to connect to the mounting system 30 of the lighting module 20, to thereby support the lighting module 20. The mounting interface 50 can include mechanical and/or magnetic mounting structure.

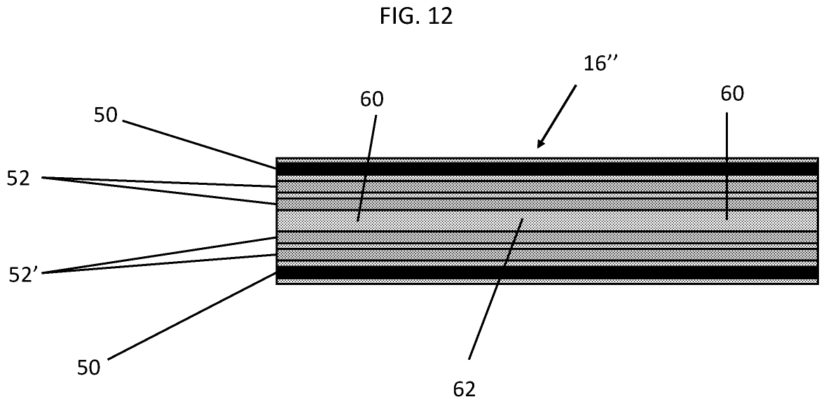

Referring to FIG. 13, in an embodiment, the lighting module 20 can comprise multiple connector modules arranged in series, which can be used to extend the length of the lighting module. For example, the lighting module 20 can comprise first and second connector modules 22, 22′ connected in series, where the light engine 34 is connected to the first connector module 22 and the second connector module 22′ is connected to the holder assembly 16, preferably in a removable and movable manner as described above.

The first connector module 22 mounts to and makes electrical and/or thermal connection to the second connector module 22′. For example, the first and second connector modules 22, 22′ can connect by a threaded connection to make a mechanical, electrical and/or thermal connection. The second connector module 22′ mounts to and make electrical and/or thermal connection to the holder assembly 16.

The first and second connector modules 22, 22′ are configured to operably pass power and/or control signals from the holder assembly 16 to the lighting module 20. The electrical conductors 32 of the first conductor module 22 align with and connect to the electrical conductors 32 of the second conductor module 22′.

The first and second connector modules 22, 22′ are also configured to dissipate heat from the light engine 34 to the holder assembly 16. The second thermal interface 28 of the first connector module 22 makes a thermal connection with the first thermal interface 26′ of the second connector module 22′, and the second thermal interface 28′ of the second connector module 22′ makes a thermal connection with the thermal interface 60 of the holder assembly 16. One or more thermal materials can be disposed between the connector modules, as a means of facilitating the thermal transfer. These can include graphite films, thermal grease, gap pads, thermal pads, or other commercially available thermal solutions.

The multiple connector modules 22, 22′ can have identical configurations such that they can be connected in any order and such that more than two such connector can be operably connected together and mounted to the holder assembly 16.

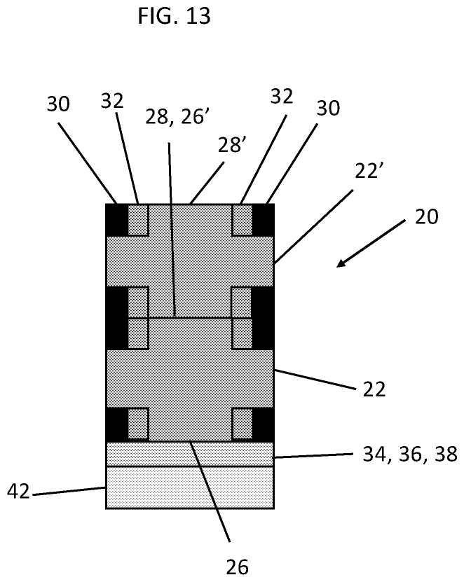

Referring to FIG. 14, in an embodiment, the lighting fixture 10 incudes a shape adapter 70 configured to mount to the second end 48 of the connector module 22 to adapt the connector module 22 to the shape of the holder assembly 16. The shape adapter 70 can have a first surface 72 having a profile complementary to the second end 48 of the connector module 22 and having a second surface 74 complementary to the shape (e.g., curve) of the holder assembly 16. The shape adapter is configured to mount to the mounting system 30 of the connector module 22 and to the mounting interface 50 of the holder assembly 16, and is preferably configured to operably pass power and/or control signals from the holder assembly 16 to the lighting module 20.

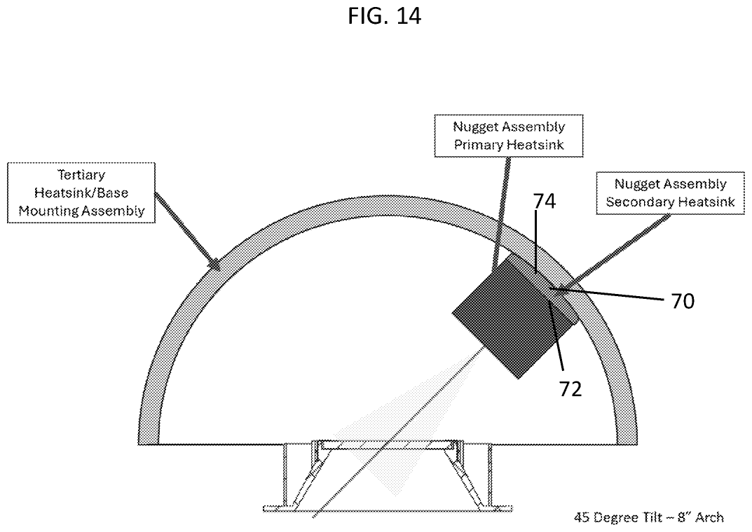

Referring to FIG. 15, in an embodiment, the lighting fixture 10 can be arranged in an inclined orientation, for example for use in a sloped ceiling installation.

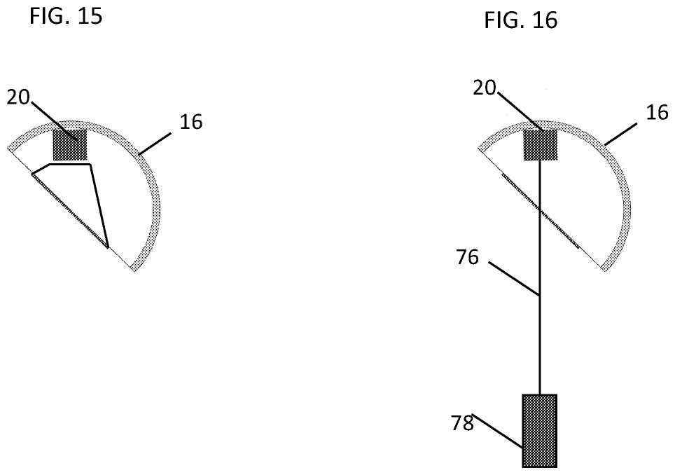

Referring to FIG. 16, in an embodiment, the lighting fixture 10 can be in the form of a pendant having a holder assembly 16 and connector module 22 as described above, and further including an elongated shaft 76 having a first end connected to the connector module 22. The light engine 34 is connected to a second end of the shaft 76, directly or indirectly, and a lower body such as a cylinder, pendant, or monopoint, which can include shades or other aesthetic components 78 (and/or optical components) can be disposed over the light engine 34. The shaft 76 is configured to pass power and/or control signals from the connector module 22 to the light engine 34.

What is claimed:

1. A modular lighting fixture comprising:
a holder assembly having a mounting interface and an electrical interface;
a lighting module;
the lighting module including a connector module having first and second ends;
the lighting module including a light engine having light emitting elements, and the light engine being mounted to the first end of the connector module;
the second end of the connector module being removably and movably mountable to the mounting interface of the holder assembly;
the connector module including electrical conductors configured to connect to the electrical interface of the holder assembly;
the light engine being connected to the electrical conductors of the connector module; and
the lighting module being operable to move along the holder assembly in a range of positions while maintaining a mounting connection to the mounting interface and an electrical connection to the electrical interface.

2. The modular lighting fixture of claim 1, wherein:
the holder assembly includes a thermal interface;
the first end of the connector module includes a first thermal interface and the second end of the connector module includes a second thermal interface;
the light engine is in thermal connection with the first thermal interface of the connector module;
the connector module comprises a material having high thermal conductivity which is configured to conduct heat from the light engine to the thermal interface of the holder assembly; and
the lighting module is operable to move along the holder assembly in the range of positions while maintaining a thermal connection to thermal interface of the holder assembly.

3. The modular lighting fixture of claim 1, wherein:
the light engine includes an integrated controller which is operable to receive power or control signals to drive the light emitting elements.

4. The modular lighting fixture of claim 1, wherein:
the holder assembly includes a substrate having a channel and the electrical interface is disposed with the channel.

5. The module lighting fixture of claim 4, wherein:
the electrical interface includes a conductor exposed along a length of the holder assembly and an electrically insulating sleeve disposed between the conductor and the substrate.

6. The modular lighting fixture of claim 1, wherein:
the modular lighting fixture is configured to connect to a support structure; and
the holder assembly is operable to rotate or translate relative to the support structure.

7. The modular lighting fixture of claim 1, further comprising:
the holder assembly having first and second electrical interfaces;
first and second lighting modules;
each lighting module including a connector module having first and second ends;
each lighting module including a light engine having light emitting elements, and the light engine being mounted to the first end of the connector module;
the second end of each connector modules being removably and movably mountable to the mounting interface of the holder assembly;
the first connector module including electrical conductors configured to connect to the first electrical interface of the holder assembly;
the second connector module including electrical conductors configured to connect to the second electrical interface of the holder assembly;
the light engine of each lighting module being connected to the electrical conductors of the associated connector module; and
each lighting module being operable to move along the holder assembly independently in a range of positions while maintaining a mounting connection to the mounting interface and an electrical connection to the electrical interface.

8. The modular lighting fixture of claim 1, wherein:
the connector module includes an elongated shaft disposed between the first and second ends of the connector module;
whereby the lighting fixture is in the form of a pendant.

9. The modular lighting fixture of claim 1, wherein:
the connector module includes a first connector module and a second connector module connected in series;
the light engine being connected to the first connector module and the second connector module being removably and moveably mountable to the holder assembly.
